(19) United States
(12) Patent Application Publication
(10) Pub. No.: US 2003/0011747 A1
(43) Pub. Date: Jan. 16, 2003

(54) Digital, high-resolution motion-picture camera

(76) Inventor: Reimar Lenz, Munchen (DE)

Correspondence Address: CROWELL & MORING, LLP, Suite 700, 1200 G Street, N.W., Washington, DC, 20005, US

(21) Appl. No.: 09/902,943

(22) Filed: Jul. 12, 2001

(30) Foreign Application Priority Data
Jul. 12, 2001 (DE) 100 33 751.1

(51) Int. Cl. G03B 1/00

(52) U.S. Cl. 352/166

(57) ABSTRACT

A digital high-resolution motion-picture camera has a receiving device for interchangeable lenses and a single area sensor with a color mosaic filter mask. The interchangeable lenses permit the cameraman to utilize the advantages of available lenses in the familiar fashion. A single area sensor avoids inferior image quality as would be unavoidable using three separate sensors for different color separations. To avoid color moiré optically effective low-pass filtering is carried out without optical components. The filtering effect is caused by image motion, i.e. blurring during the particular detecting time of the sensor (10).

This invention relates to a digital, high-resolution motion-picture camera.

The present invention is intended to provide a motion-picture camera of the customary 35-mm motion-picture format for recording and storing moving pictures which does without customary photochemical film materials, instead using electronic sensor technology in conjunction with digital storage media.

In the consumer sector (home movies) there have for some time been electronic movie cameras (so-called camcorders) which have totally supplanted 8-mm film (e.g. Super-8) through the use of CCD sensors and magnetic tapes. However, their resolution (480 or 580 lines) is insufficient for projection on a large screen. This requires at least 1920×1080 pixels (as e.g. in high definition television, HDTV). Digital video cameras are described e.g. in EP-A-0 083 240 and EP-A-0 131 387. However, even more pixels are desirable: a good 35-mm movie film with an optical resolution of 60 line pairs per millimeter attains about 2900 pixels on its exposed width of 24 mm and about 2200 pixels on its height of 18 mm.

In the professional studio sector there have for some years been digital HDTV cameras with the necessary minimal resolution. To obtain image scanning free from color moire they use almost exclusively three CCD sensors in conjunction with a beam splitting prism for the three color separations, red, green and blue. Because of this prism one cannot use lenses designed and calculated for conventional 35-mm motion-picture cameras. Due to the considerable thickness of the prism located in the nonparallel beam path, the optical properties of said lenses would be too strongly influenced unfavorably. Therefore no interchangeable lenses find application in HDTV cameras because they would have to be calculated for the prism used. In addition, said cameras have no optical viewfinder but rather an electronic viewfinder, in the form of a small monitor (cathode-ray tube or liquid crystal display, LCD).

For a cameraman in movie production such a procedure is unacceptable. His know-how includes the knowledge he has attained in decades about the characteristics of a large number of different film lenses. These also constitute a major part of the rental equipment investments for motion-picture cameras. In addition, the cameraman needs an optical viewfmder for work free from fatigue. Also, this viewfinder should show a larger area of the picture than the actually recorded area so that the cameraman can recognize early which parts of the scene would come into the picture by a pan and he can react in time to undesirable scene elements (microphones, extras, etc.) threatening to enter the frame area.

Simple replacement of the film carrier in a conventional 35-mm motion-picture camera by a prism block equipped with three sensors is therefore impossible. The alternative approach of using only a single sensor (without a prism) equipped with a color mosaic filter mask for color recovery, as in a consumer camera, has already failed in thought hitherto due to the seemingly inevitable resolution losses and interference by color moire. Nevertheless, the present invention pursues this path.

The causes of the problems of replacing conventional chemical color film by “electronics” are as follows.

A chemical color film consists of layers sensitive to different colors, with irregularly disposed silver grains. In contrast, a CCD or CMOS image sensor has only one “light-sensitive layer,” with sensor elements disposed in a regular grid. If different color separations are to be recorded with only one such sensor simultaneously (i.e. not in sequential time multiplex), they must be obtained in space multiplex, i.e. with adjacent sensor elements with different color filters. An example of such a color filter assembly is the so-called Bayer mask.

However, such a regular color filter assembly is extremely sensitive to color falsifications when recording regular structures which are imaged on the sensor as spatial frequencies which correspond approximately to the scanning spatial frequencies given by the color mosaic mask. Scanning causes said high spatial frequencies to be mixed down to low spatial frequencies close to zero, which is expressed as color stripes for the individual colors because of the 180° phase shift of scanning, even if the original was achromatic.

This phenomenon is known as so-called color moiré or color alias and is so disturbing that the use of a single sensor with a color mosaic mask seemed out of the question for high-quality image recording.

In electronic cameras in the consumer sector, one usually resorts to a diffuser. This is an optical element brought into the beam path and selectively blurring the image. One most frequently uses birefringent media which pass one polarization direction unchanged but deflect the perpendicular one by a certain angle (typically six milliradians). In order to obtain the blur necessary for relatively great sensor element distances one requires a diffuser with a thickness of several millimeters. This conflicts with the requirement that the quality of a lens designed for use without a diffuser should not be essentially worsened. Furthermore, this method does not work when light entering the lens is already polarized.

An alternative measure for low-pass filtering with a diffuser is defocusing. However, this is impracticable for several obvious reasons, in particular when recording nonplanar objects.

The invention is based on the problem of stating a digital, high-resolution motion-picture camera which is practically free from color moire or color alias at the desired high resolution without impairment of the high image quality ensured by the quality of the camera lens used.

This problem is solved by a digital, high-resolution motion-picture camera having the following features:

a receiving device for conventional interchangeable lenses;

a single area sensor with sensor elements and with a color mosaic filter mask; and

an optically effective low-pass filter device doing without optical components.

An essential element for a motion-picture camera, thus also for the digital motion-picture camera claimed here, is, apart from high resolution, the use of conventional interchangeable lenses. As far as the abovementioned disadvantage of using three separate area sensors for the different color separations is concerned, such disadvantages are avoided by the use of a single area sensor. The problems typical of said single area sensor with a color mosaic filter, that is, the formation of color moiré or color alias, are avoided according to the invention by an optically effective low-pass filter device doing without optical components. Low-pass filtering is obtained by selective utilization of motion blur. In a special embodiment, the formation of such motion blur is effected by two-dimensional shifting of the sensor in the image plane during the exposure time (aperture synthesis).

Within the image plane the area sensor can follow different motion paths. Depending on the course of said paths, the speeds at which the sensor is moved, and the times it dwells at different places in the course of the motion, one obtains almost any desired two-dimensional positive-value optical point spread function. The Fourier transform of said point spread function is the so-called system transfer function, and its absolute value is in turn the modulation transfer function (MTF).

For a given color mosaic mask one can determine which spatial frequencies would cause color moiré disturbances in the image. Said spatial frequencies can then be selectively suppressed by a suitably selected MTF or point spread function.

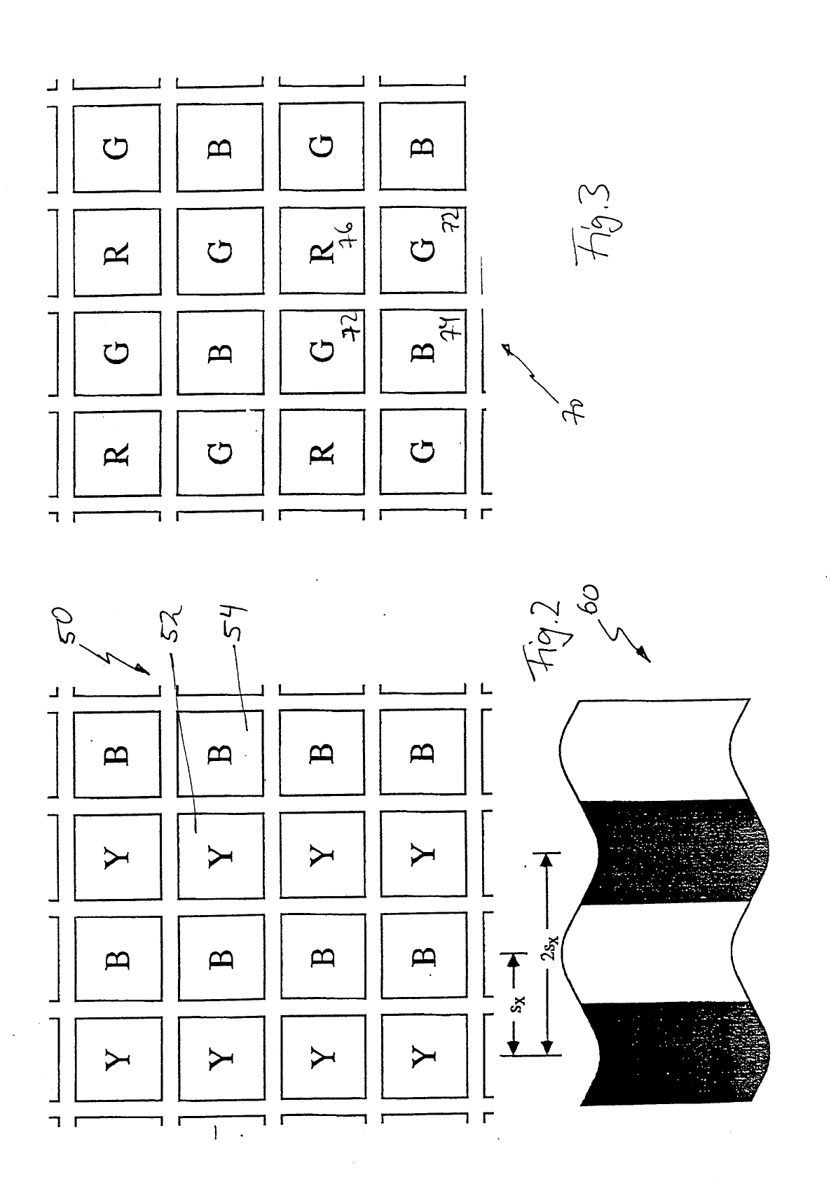

This will be explained more closely with reference to a simple example with only two instead of the at least three colors basically necessary, reference being made to the enclosed FIG. 2. One uses here a simplified assembly with a color filter mask varying only one-dimensionally (in the horizontal direction or from the left to the right). FIG. 2 shows sensor 50 with a color mosaic mask for the colors blue and yellow. The color mosaic pattern contains filter elements 52 for the color yellow (Y) and filter elements 54 for the color blue (B). The effects and properties illustrated by the example shown in FIG. 2 result analogously with two-dimensionally varying color filter masks, for example the so-called Bayer mask which is shown more closely in FIG. 3.

Sensor 50 according to FIG. 2 has a horizontal pixel distance of sₓ. Accordingly, a color cell has a width of 2·sₓ with two adjacent sensor elements due to the alternating yellow and blue vertical color mask stripes.

With sensor 50 and the color mosaic mask located thereon one now records achromatic original 60 formed in the present example by a vertical black-and-white periodic stripe pattern. Let it be assumed here that original 60 is imaged onto sensor 50 with period (2 sₓ) which corresponds to the width of a color cell. In this case the achromatic original can be detected more or less distinctly in color. When the black areas of the original fall onto filter elements 52 (yellow) for example, sensor 50 delivers exclusively signals from picture elements 54 receiving light from the bright areas of original 60 so that as a result the sensor detects a full “blue.” Upon a shift of imaged original 60 relative to sensor 50 by half the period sₓ, sensor 50 would detect exclusively “yellow.” When from each white area of original 60 light falls onto half a filter element 52 and light onto half a filter element 54 (shift of ½ sₓ), sensor 50 detects “gray.”

In the example according to FIG. 2 selected here, the imaging of stripe pattern 60 has the same period as the color mask, and therefore sensor 50 can in principle not distinguish whether the original involves a homogeneous yellow or homogeneous blue area, or an achromatic stripe pattern. To avoid this ambiguity one must make sure from the start that the sensor is not confronted with patterns whose spatial frequency (reciprocal of the period) corresponds to the reciprocal of the color cell width.

The MTF must have high attenuation at this spatial frequency for the above situation to be avoided.

Attenuation of spatial frequencies is obtained according to the invention by motion of the sensor during the exposure time. This leads to an image blur. Said blur can be effected firstly by approximatively uniform motion (linear blurring, similar to the blur when photographing), or by step-by-step motion (producing offset double or multiple images, similar to a double or multiple exposure), or by a combination of the two measures, that is, a combination of approximatively uniform motion and step-by-step motion.

The above-explained principle of the optically effective low-pass filter device by moving the sensor in the image plane is similar with two-dimensionally varying color filter masks, as explained above. The color filter mask shown in FIG. 3 has filter elements 72 for green (G) which occupy 50% of total color filter mask 70 and alternate in the horizontal and vertical directions with filter elements 74 for blue (B) and with filter elements 76 for red (R). One can easily imagine that a checkered original which is imaged onto sensor 70 with the same period as defines the cell size covers all filter elements 74 and 76, depending on the position of the original, so that sensor 70 delivers exclusively signals for green (G). The above considerations in conjunction with FIG. 2 apply to the color filter mask shown in FIG. 3 accordingly two-dimensionally, i.e. in all directions in the plane.

The image blur obtained by the sensor motion is obtained, as mentioned, by approximately uniform and/or step-by-step motion of the sensor. However, all kinds of motion are fundamentally possible for attaining the low-pass filter effect, i.e. also accelerated motion and motion with a complicated curved course.

In an embodiment of the invention it is provided that an optical viewfinder is disposed in the beam path behind the interchangeable lens of the inventive camera. Said optical viewfinder offers the trained cameraman the possibility of trying out and using the special characteristics of the interchangeable lens available to him. In particular, the optical viewfinder image is faded out with a semitransparent mirror behind the interchangeable lens. Part of the image information falls onto the area sensor, part of the image falls onto a ground-glass screen.

The semitransparent mirror can be formed in advantageous fashion as an infrared cutting filter for the sensor. To suppress interference by dust, the semitransparent mirror can be formed as a rotating mirror.

An especially favorable embodiment for realizing the optically effective low-pass filter device is according to the invention that it has a shifting device for two-dimensionally shifting the area sensor during the exposure time, the shifting device or shifting mechanism preferably being formed by means of piezomechanical actuators. Such piezomechanical actuators are known from the prior art (for example EPA-0 124 250).

With the aid of the two-dimensional shift of the sensor during the exposure time one can synthesize an optical point spread function which, without appreciable loss of focus, suppresses those spatial frequencies which would cause color moiré interference.

It is preferred for the area sensor to be formed as a CMOS sensor. The color mosaic filter mask used is preferably the Bayer mask.

In a special embodiment, the invention provides that the area sensor is mounted so as to be inclinable or swivel. This permits additional focusing according to Scheimpflug.

The digital camera according to the invention has a control device which controls almost all electronic parts and components of the camera. In particular it is provided that the control device permits variation or adjustment of the frame rate. This permits slow-motion and fast-motion effects to be obtained in simple fashion.

Preferably, the effective exposure time is variable from zero to the reciprocal of the frame rate. This measure avoids motion blur. Higher frame rates are obtained by underscanning of the area sensor, which is preferably a CMOS sensor. As an additional or alternative measure one can provide only a reduced area of the CMOS sensor for the readout process.

Underscanning of the sensor (for example only every third sensor element is read out, the two adjacent sensor elements are disregarded) causes a lower scanning spatial frequency to be obtained; this must be taken into account in the motion blur. In a special development of the invention it is provided that the CMOS area sensor is read out alternatively from the top to the bottom or from the bottom to the top. This manner of reading out the sensor corresponds to a downwardly or upwardly moved slotted shutter of a conventional camera. The resulting apparent slight inclination of vertical lines upon a lateral camera pan in or against the moving direction can be used effectively for artistic purposes.

For particular consideration of the selected frame rate and exposure time, it is provided in a development of the invention that an optically effective shutter (liquid crystal (LC) shutter) is located in the viewfinder beam path. Said shutter is driven in accordance with the frame rate and the exposure time so that the camera is given the proper impression of motion (jerking of the image).

In order to take the high resolution and high frame rates into account, the storage of the images is effected according to an embodiment of the invention in semiconductor memory cells during recording. Said cells are cleared for recording the next image sequence after or already beginning during recording by transfer of the image data to bulk memories (for example hard disks).

The possible optical viewfinder in the inventive motion-picture camera is of particular advantage, as explained above. As an additional device, a high-resolution control image with a high refresh rate (e.g. 72 Hz) for a computer monitor is generated from the digital image data parallel to the optical viewfinder image. On the one hand, the control image can have the same frame rate as the sensor during recording. On the other hand, the control image can be reproduced at another, fixed frame rate (for example 24 Hz). Thus, every image is shown exactly three times at a refresh rate of the control image of 72 Hz. This permits slow-motion and fast-motion effects to be visualized immediately.

The inventive digital and high-resolution motion-picture camera can also be used for recording still pictures. In this case the optically effective low-pass filter device is not used for low-pass filtering but for so-called microscanning. The term “microscanning” means that a plurality of slightly offset images of a stationary object are successively recorded with optically multiplied resolution; using customary CMOS sensors one can obtain three- to fourfold recordings in two-dimensional offset.

In the following an example of a digital, high-resolution motion-picture camera will be explained more closely with reference to the drawing, in which:

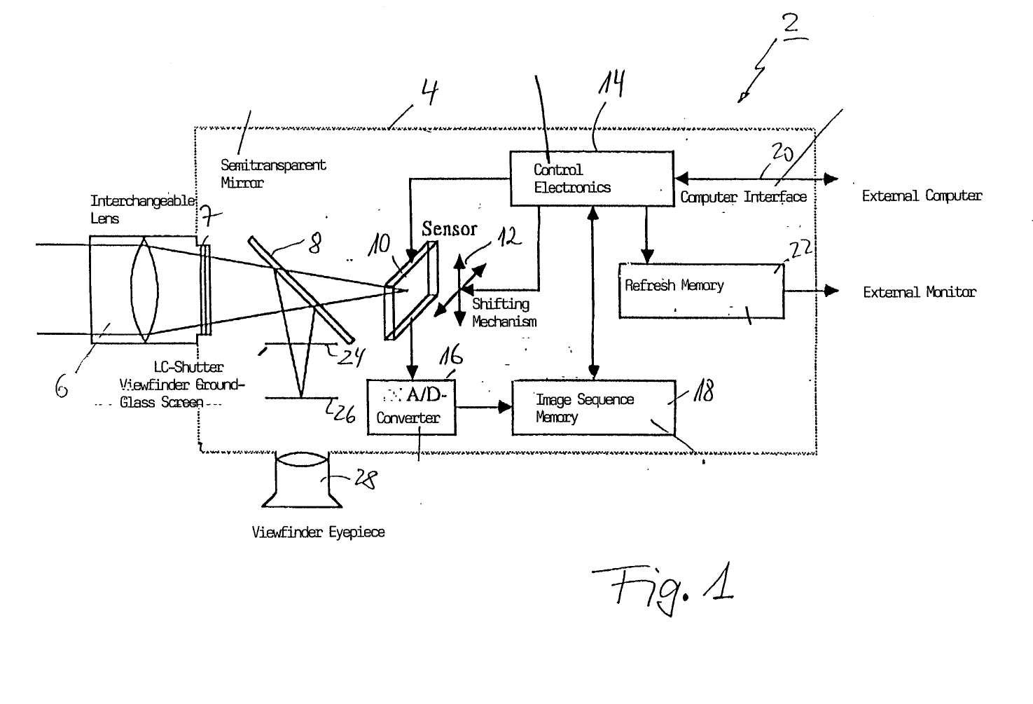

FIG. 1 shows a schematic view of a digital, high-resolution motion-picture camera according to an embodiment of the invention, FIGS. 2 and 3 show different color mosaic filter masks for an area sensor to illustrate the problem due to color moiré, FIGS. 4 to 6 show graphic representations of functions to explain the basic principle underlying the present invention.

FIG. 1 schematically shows high-resolution digital motion-picture camera 2 with housing 4 indicated by a rectangle and having receiving apparatus 7 for interchangeable lens 6. In the beam path behind interchangeable lens 6 there is within camera housing 4 semitransparent mirror 8 acting as an IR cutting filter which passes part of the light passing through the interchangeable lens onto CMOS area sensor 10, and visualizes another part of the light via LC shutter 24 and viewfinder ground-glass screen 26 for viewing through viewfinder eyepiece 28.

The CMOS area sensor contains a color mosaic filter mask not shown in FIG. 1, shown by way of example as a so-called Bayer mask in FIG. 3. There is merely an indication of shifting mechanism 12 for shifting the sensor two-dimensionally, that is, horizontally and vertically, during the exposure time. The shifting mechanism preferably consists of piezomechanical elements which are known from the print stated at the outset.

The heart of the camera is formed by control electronics 14 performing the readout of sensor 10 as well as the drive of shifting mechanism 12 in such a way that a for example linear or step-by-step shift of sensor 10 is effected along for example a two-dimensional pathway during each exposure time.

The image signals read out of sensor 10 under the control of control electronics 14 are inputted to image sequence memory 18 via A/D converter assembly 16 containing a plurality of converters. The image signals stored there are fed via the control electronics and computer interface 20 to an external computer to be stored in a bulk memory there.

The cameraman can view the image during recording or before recording via viewfinder eyepiece 28 in the way it is detected by sensor 10. Alternatively, viewing is possible via an external monitor not shown here. For this purpose the image data taken from image sequence memory 18 via control electronics 14 are inputted to refresh memory 22 and are available for representation on the external monitor.

Sensor 10 can be inclined or swiveled with an apparatus not shown in detail in FIG. 1 in order to perform additional focusing according to Scheimpflug. The necessary adjusting means are not shown in FIG. 1 so as not to overburden the drawing.

LC shutter 24 is driven with the frame rate and exposure time with which sensor 2 is also operated. This gives the cameraman the proper impression of motion.

Control electronics 14 can read out the sensor in special fashion, i.e. from the top to the bottom and from the bottom to the top, thereby creating the impression of a slotted shutter. Control electronics 14 can be programmed to attain all peculiarities of control which are stated in the introduction to the description.

To explain the basic principle of the present invention, reference shall be made in the following to FIGS. 4 to 6.

For the example we will restrict ourselves to one-dimensional motion since it suffices for a color mask varying only one-dimensionally. It is then also easier to calculate the modulation transfer function—it is simply the one-dimensional Fourier transform of the point spread function synthesized by the motion.

The following two Fourier correspondences between space domain and spatial frequency domain are of particular practical relevance:

1. Point spread function pₗ (l standing for linear blur) in the space domain: a straight line in the x direction of length Δx, with uniform brightness load, generated by rectilinear motion at constant speed during the total exposure time, shown on the left side in FIG. 4.

The associated MTFₗ, i.e. the Fourier transform of point spread function pₗ, is a so-called Si function (sin x/x), more precisely:

MTFᵤ(u)=sin(π·Δx·u)/(π·Δx·u),

where u is the spatial frequency, e.g. in line pairs per millimeter. This function has its first zero at u₀=1/Δx since sin(π)=0. With a color stripe mask with color cell size 2·sₓ one must prevent the sensor from being subjected to the spatial frequency Uₘ=1(2·sₓ). If one thus selects 1/Δx=u₀=uₘ=1(2·sₓ) or the length of the blurring line Δx=2·sₓ disturbing spatial frequency uₘ is suppressed by the zero of the MTFₗ at u₀, as required.

Since color cell size 2·sₓ of sensor 10 is known, the programming stored in control electronics 14 can be set up such that the shift of the sensor is effected in accordance with length Δx. Sensor 10 is controlled in its motion such that the length of the motion path in the x direction corresponds to the value Δx, within the effective exposure time.

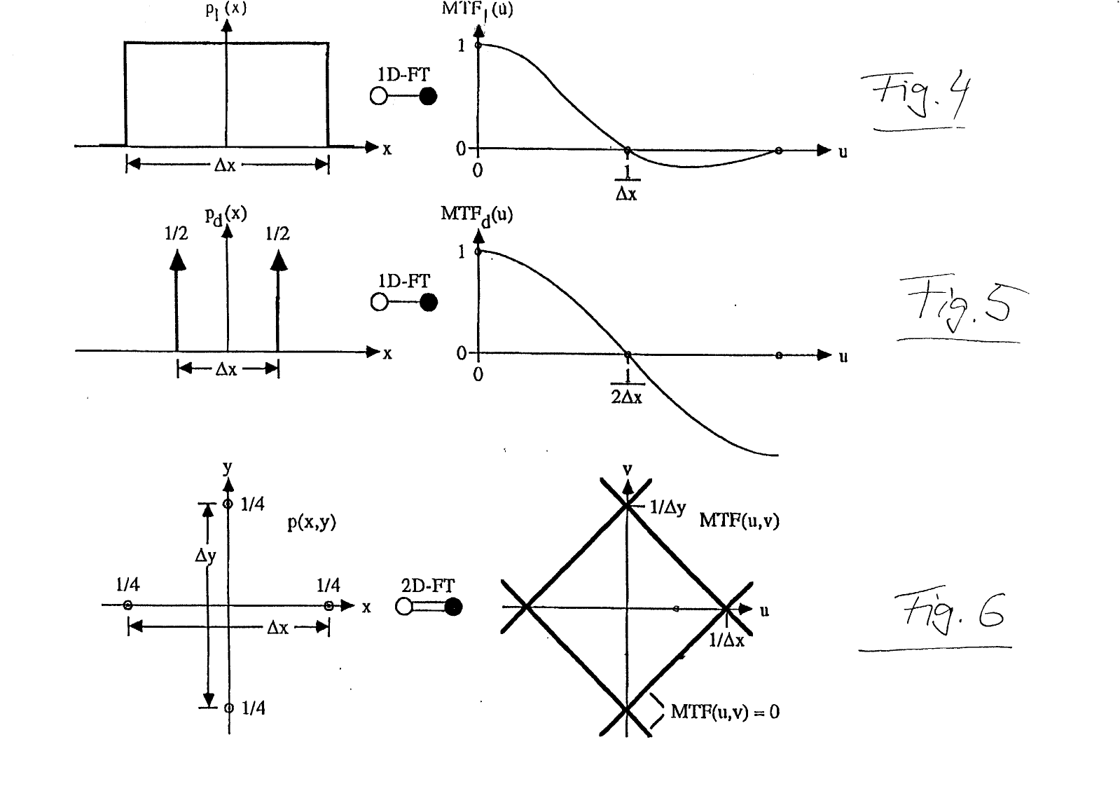

2. Point spread function p_{d} in the space domain: A double point in the x direction with distance Δx, with two equally bright points, generated e.g. by an ideally step-shaped motion between two points with distance Δx and a dwell time of half the total exposure time in each case, compare FIG. 5.

The associated MTF is a cosine function, more precisely:

MTFₗ(u)=cos(π·Δx·u).

This function has its first zero at u₀ (=1/(2·Δx) since cos(π/2)=0. The spatial frequency uₘ=1(2·sₓ) is therefore suppressed when Δx=sₓ is selected. A sensor with the color mosaic mask stated by way of example would thus have to be shifted precisely by sensor element distance sₓ in order to achieve the desired double exposure or associated MTF.

Of interest are also point spread functions resulting from a combination of rectilinear motions at constant speed and short-term dwelling at several places. Two-dimensionally varying MTFs are achieved by two-dimensional motion paths (compare FIG. 6). Of particular importance for calculating the MTF(u, v) from impulse response p(x, y) is the so-called central-slice theorem. The section through the MTF for example along the u-axis, i.e. the MTF(u, v=0), is the Fourier transform of the projection of the impulse response p(x, y) on the x-axis, i.e. the integral ∫p(x, y)dy of y=−∞ to y=+∞.

With the inventive camera one can also take stills with flashlight. The motion sequence for shifting the sensor is then synchronized with the duration of the flash-light illumination. For example, it is ensured (through control electronics 14) that the shift of the sensor begins approximately with the firing of the flash and is ended with the end of the firing time (or shortly before or after).

1. A digital, high-resolution motion-picture camera having the following features:
a receiving device (7) for a conventional interchangeable lens (6);
a single area sensor (10) with regularly disposed sensor elements and with a color mosaic filter mask; and
an optically effective low-pass filter device (12, 14) doing without optical components.

2. A camera according to claim 1, with an optical viewfinder for the beam path behind the interchangeable lens.

3. A camera according to claim 2, including a semitransparent mirror (8) for deriving the optical viewfmder image.

4. A camera according to claim 3, characterized in that the semitransparent mirror (8) is simultaneously formed as an infrared cutting filter for the sensor (10).

5. A camera according to claim 3 or 4, characterized in that the semitransparent mirror (8) is mounted so as to rotate.

6. A camera according to any of claims 2 to 5, characterized in that an optically effective shutter (24) is disposed in the viewfinder beam path and driven in particular with the frame rate and exposure time of the sensor (10).

7. A camera according to any of claims 1 to 6, characterized in that the low-pass filter device has a shifting mechanism (12) for two-dimensionally shifting the sensor (10) during the exposure time.

8. A camera according to claim 7, characterized in that the shifting mechanism has piezomechanical actuators.

9. A camera according to any of claims 1 to 8, characterized in that the sensor (10) is a CMOS sensor.

10. A camera according to any of claims 1 to 9, characterized in that the color mosaic filter mask is a so-called Bayer mask.

11. A camera according to any of claims 1 to 10, characterized in that the sensor is mounted so as to be inclinable and swivel.

12. A camera according to any of claims 1 to 11, with a control device which controls at least the operation of the sensor (10).

13. A camera according to claim 12, characterized in that the frame rate is adjustable via the control device (14).

14. A camera according to claim 13, characterized in that the effective exposure time is variable from zero to the reciprocal of the frame rate.

15. A camera according to claim 13, in particular in conjunction with a CMOS sensor, characterized in that, to attain higher frame rates
a) underscanning of the sensor is effected, and/or
b) a reduction of the readout area of the sensor is effected.

16. A camera according to any of claims 1 to 15, wherein the sensor (10) is read out alternatively from the top to the bottom or from the bottom to the top.

17. A camera according to any of claims 1 to 16, characterized in that the image data accumulating during recording are stored in semiconductor memory cells to be transferred to a bulk memory after or already beginning during recording.

18. A camera according to any of claims 2 to 17, characterized in that a high-resolution control image with a high refresh rate (e.g. 72 Hz) for a-computer monitor is generated in addition to the optical viewfinder image with the aid of the digital image data detected by the sensor (10).

19. A camera according to claim 18, characterized in that the control image is generated at the same frame rate at which the sensor is operated.

20. A camera according to claim 18, characterized in that the recorded image is reproduced using a fixed frame rate which is lower than the refresh rate upon generation of the control image during recording.

21. A camera according to any of claims 7 to 20, characterized in that in case of flashlight illumination the motion sequence for shifting the sensor is synchronized with the firing time of the flash for at least one image.

22. Use of the digital, high-resolution motion-picture camera according to claim 1 for recording individual still pictures, whereby a plurality of slightly offset images of a stationary object are successively recorded with the area sensor.
